(19) United States
(12) Patent Application Publication
(10) Pub. No.: US 2023/0325236 A1
(43) Pub. Date: Oct. 12, 2023

(54) INFORMATION PROCESSING SYSTEM, INFORMATION PROCESSING METHOD, AND NON-TRANSITORY RECORDING MEDIUM

(71) Applicant: Tatsuya HIGUCHI, Kanagawa (JP)

(72) Inventor: Tatsuya HIGUCHI, Kanagawa (JP)

(21) Appl. No.: 18/119,841

(22) Filed: Mar. 10, 2023

(30) Foreign Application Priority Data
Mar. 18, 2022 (JP) 2022-044243
Nov. 29, 2022 (JP) 2022-189931

(51) Int. Cl. G06F 9/48; G06F 9/54

(52) U.S. Cl. CPC G06F 9/4881; G06F 9/547

(57) ABSTRACT

An information processing system, an information processing method, and a non-transitory recording medium. The information processing system stores in response to an operation on an administrator terminal, execution requests for executing one or more tasks in a first memory, executes the one or more tasks, acquires the one or more tasks stored in the first memory, assigns the one or more tasks to one or more applications of the plurality of applications, transmits to each application to which the task is assigned, detailed information related to an execution of the task, and transmits, in response to a request from each application to which the task is assigned, execution data to be used for executing the task to the application.

### CROSS-REFERENCE TO RELATED APPLICATIONS

This patent application is based on and claims priority pursuant to 35 U.S.C. §119(a) to Japanese Patent Application No. 2022-044243. filed on Mar. 18, 2022. and Japanese Patent Application No. 2022-189931, filed on Nov. 29, 2022, in the Japan Patent Office, the entire disclosure of which is hereby incorporated by reference herein.

### BACKGROUND

### Technical Field

The present disclosure relates to an information processing system, an information processing method, and a non-transitory recording medium.

### Background Art

A known cloud system manages various devices residing in an environment protected by a firewall.

As a technology implemented by the cloud system, a disclosed information processing server communicably connected to a processing apparatus provided in an internal network to which access from the cloud system for providing a cloud service is restricted, acquires a job managed by the cloud system and instructs the processing apparatus to execute a process predetermined according to the acquired job.

### SUMMARY

Embodiments of the present disclosure describe an information processing system, an information processing method, and a non-transitory recording medium. The information processing system stores in response to an operation on an administrator terminal, execution requests for executing one or more tasks in a first memory, executes the one or more tasks, acquires the one or more tasks stored in the first memory, assigns the one or more tasks to one or more applications of the plurality of applications, transmits to each application to which the task is assigned, detailed information related to an execution of the task, and transmits, in response to a request from each application to which the task is assigned, execution data to be used for executing the task to the application.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating an example of an overall configuration of a device management system according to a first embodiment of the present disclosure;

FIG. 2 is a block diagram illustrating an example of a hardware configuration of a cloud system according to the first embodiment of the present disclosure;

FIG. 3 is a block diagram illustrating an example of a hardware configuration of a device according to the first embodiment of the present disclosure;

FIG. 4 is a block diagram illustrating an example of a functional configuration of the device management system according to the first embodiment of the present disclosure;

FIGS. 5A and 5B are sequence diagrams illustrating an example of a task registration process executed by the device management system according to the first embodiment of the present disclosure;

FIGS. 6A and 6B are sequence diagrams illustrating an example of a task execution process executed by the device management system according to the first embodiment of the present disclosure;

FIG. 7 is a block diagram illustrating an example of a functional configuration of the device management system according to a second embodiment of the present disclosure:

FIGS. 8A and 8B are sequence diagrams illustrating an example of the task registration process executed by the device management system according to the second embodiment of the present disclosure;

FIGS. 9A and 9B are sequence diagrams illustrating an example of the task execution process executed by the device management system according to the second embodiment of the present disclosure:

FIG. 10 is a diagram illustrating an example of data structure of notification destination information;

FIG. 11 is a block diagram illustrating an example of a functional configuration of the device management system according to a third embodiment of the present disclosure;

FIGS. 12A and 12B are sequence diagrams illustrating an example of the task execution process executed by the device management system according to the third embodiment of the present disclosure;

FIG. 13 is a block diagram illustrating an example of a functional configuration of the device management system according to a fourth embodiment of the present disclosure: and

FIGS. 14A and 14B are sequence diagrams illustrating an example of a task execution determination process in the task execution process executed by the device management system according to the fourth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of an information processing system, an information processing method, and a non-transitory recording medium according to the present disclosure are described in detail with reference to the drawings. The present disclosure, however, is not limited to the following embodiments, and the constituent elements of the following embodiments include elements that can be easily conceived by those skilled in the art, those being substantially the same ones, and those being within equivalent ranges. Furthermore, various omissions, substitutions, changes and combinations of the constituent elements can be made without departing from the gist of the following embodiments.

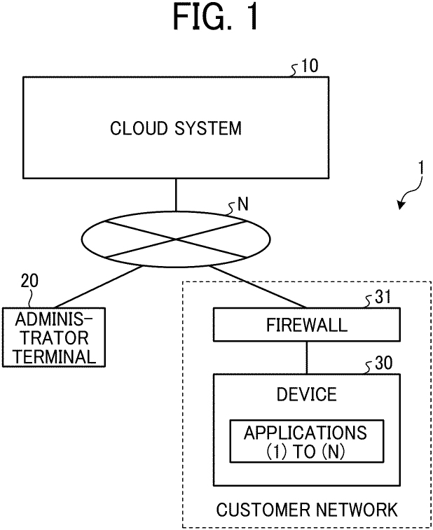

FIG. 1 is a block diagram illustrating an example of an overall configuration of a device management system according to a first embodiment of the present disclosure. The overall configuration of the device management system 1 according to the present embodiment is described with reference to FIG. 1.

The device management system 1 illustrated in FIG. 1 is a system for causing a plurality of devices 30 to execute tasks requested from an administrator terminal 20. The device management system 1 includes a cloud system 10, the administrator terminal 20, and the device 30 and a firewall 31 in the customer network, as illustrated in FIG. 1. These devices are capable of data communication with each other through the network N. In addition, although one device 30 is illustrated in the customer network in FIG. 1, the number of devices is not limited to one and may include a plurality of devices 30. In addition, although one customer network is illustrated in FIG. 1, number of networks is not limited to one, and a plurality of customer networks may be included.

The network N is a network including the internet because the cloud system 10 is used in the present embodiment. In addition, a local area network (LAN), a wide area network (WAN), and the like are used in the customer network. The network N may use a virtual private network (VPN).

The cloud system 10 is a system for receiving a task execution request from the administrator terminal 20 and causing the device 30 on the customer network to execute the task corresponding to the task execution request. The cloud system 10 may include a single information processing apparatus such as a server, or may include a plurality of information processing apparatuses.

The administrator terminal 20 is an information processing apparatus for requesting the cloud system 10 to create a task template for an application of the device 30 and for requesting execution of the task.

The device 30 periodically acquires a list of tasks from the cloud system 10 and causes a corresponding application to execute the tasks included in the list. As illustrated in FIG. 1, the device 30 is installed with a plurality of applications (application (1) to application (N)), and tasks are executed by these applications. The device 30 is, for example, an image forming apparatus, a scanner, a projector, an electronic whiteboard, a tablet terminal, or the like. In the present embodiment, the device 30 is described as the image forming apparatus.

The firewall 31 is an information processing apparatus for protecting against unauthorized access from the outside, and prevents the cloud system 10 from directly communicating with the device 30.

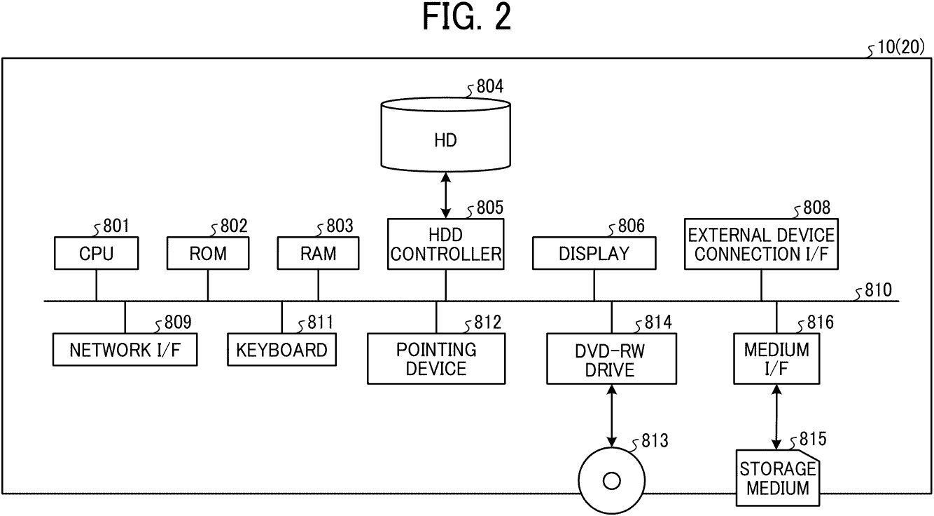

FIG. 2 is a block diagram illustrating an example of a hardware configuration of the cloud system according to the first embodiment of the present disclosure. The hardware configurations of the cloud system 10 and the administrator terminal 20 are described with reference to FIG. 2. Here, the hardware configuration of the information processing apparatus that implements the cloud system 10 and the administrator terminal 20 is described.

As illustrated in FIG. 2, the information processing apparatus includes a central processing unit (CPU) 801. a read only memory (ROM) 802, a random access memory (RAM) 803, a hard disk (HD) 804, a hard disk drive (HDD) controller 805, a display 806. an external device connection interface (I/F) 808, a network I/F 809, a keyboard 811, a pointing device 812, a Digital Versatile Disc ReWritable (DVD-RW) drive 814, and a medium I/F 816.

These devices are connected by a bus line 810 such as an address bus and a data bus so as to enable data communication.

The CPU 801 is a processor that controls an entire operation of the information processing apparatus. The ROM 802 is a non-volatile storage device that stores programs used to drive the CPU 801, such as an Initial Program Loader (IPL). The RAM 803 is a volatile storage device used as a work area for the CPU 801.

The HD 804 is a non-volatile auxiliary storage device that stores various data such as the programs.

The HDD controller 805 is a controller that controls reading or writing of various data from and to the HD 804 under the control of the CPU 801. Note that the HD 804 and HDD controller 805 may be a solid state drive (SSD).

The display 806 is a display device that displays various types of information such as cursors, menus, windows, characters, and images. The external device connection I/F 808 is an interface for connecting various external devices. The external device in this case includes, for example, a Universal Serial Bus (USB) memory or a printer. The network I/F 809 is an interface for data communication through the network N, and is capable of communication conforming to, for example, ETHERNET (registered trademark) and Transmission Control Protocol/Intemet Protocol (TCP/IP).

The keyboard 811 is an input device having a plurality of keys for inputting characters, numerical values, various instructions, and the like. The pointing device 812 is an input device such as a mouse for selecting and executing various instructions, selecting a processing target, moving a cursor, and the like.

The DVD-RW drive 814 is a device that controls reading and writing of various data from and to a Digital Versatile Disc (DVD) 813, such as a Digital Versatile Disc Recordable (DVD-R) or DVD-RW, which are examples of a removable recording medium. The medium I/F 816 is an interface that controls reading or writing (storage) of data from and to a storage medium 815 such as a flash memory.

Note that the hardware configuration of the cloud system 10 and the information processing apparatus that implements the administrator terminal 20 illustrated in FIG. 2 is an example, and not all the components illustrated in FIG. 2 may be included, or the components other than the components illustrated in FIG. 2 may be included. Further, the information processing apparatuses that implement the cloud system 10 and the administrator terminal 20 may have different hardware configurations.

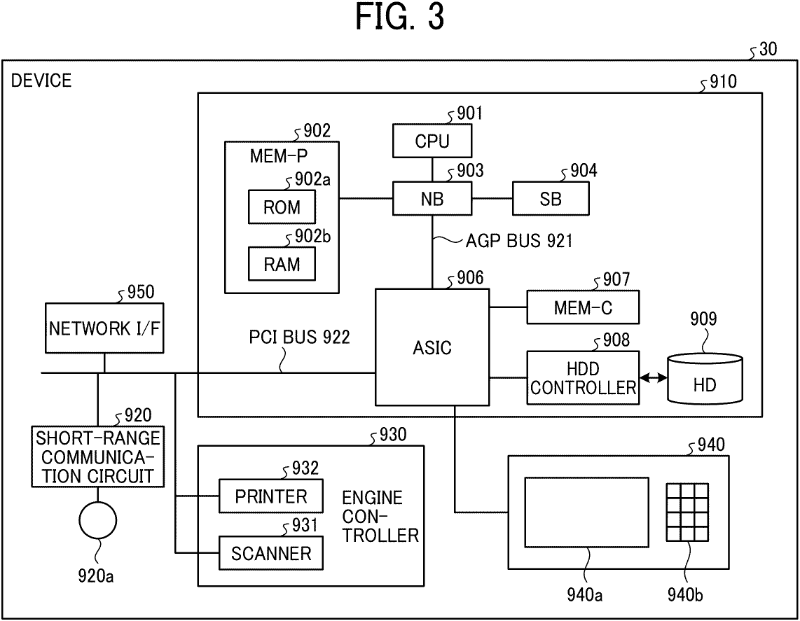

FIG. 3 is a block diagram illustrating an example of a hardware configuration of the device according to the first embodiment of the present disclosure. The hardware configuration of the device 30 is described with reference to FIG. 3. As described above, the device 30 is described as the image forming apparatus.

As illustrated in FIG. 3, the device 30 includes a controller 910, a short-range communication circuit 920, an engine controller 930, a control panel 940, and a network I/F 950.

The controller 910 includes a CPU 901 as a main processor of the computer, a system memory (MEM-P) 902. a north bridge (NB) 903, a south bridge (SB) 904, an application specific integrated circuit (ASIC) 906, a local memory (MEM-C) 907 as a storage unit, an HDD controller 908, and an HD 909 as a storage unit.

Among these components, the NB 903 and the ASIC 906 are connected by an Accelerated Graphics Port (AGP) bus 921.

The CPU 901 is a processor that performs overall control of the device 30. The NB 903 connects the CPU 901 with the MEM-P 902, SB 904, and AGP bus 921. The NB 903 includes a memory controller for controlling reading or writing of various data with respect to the MEM-P 902, a Peripheral Component Interconnect (PCI) master, and an AGP target.

The MEM-P 902 includes a ROM 902a which is a memory for storing programs and data that implements each function of the controller 910, and a RAM 902b which is used as a memory for developing programs and data and a memory for drawing at the time of memory printing. The program stored in the ROM 902a may be stored in any computer-readable storage medium, such as a compact disc-read only memory (CD-ROM), compact disc-recordable (CD-R), or digital versatile disc (DVD), in a file format installable or executable by the computer for distribution.

The SB 904 is a bridge for connecting the NB 903, PCI devices, peripheral devices, and the like. The ASIC 906 is an integrated circuit (IC) dedicated to an image processing use, and connects the AGP bus 921, a PCI bus 922, the HDD controller 908, and the MEM-C 907. The ASIC 906 includes a PCI target and AGP master, an arbiter (ARB) that forms the core of the ASIC 906, a memory controller that controls the MEM-C 907, a plurality of Direct Memory Access Controllers (DMACs) that rotate image data by hardware logic, and a PCI unit that transfers data between the scanner 931 and the printer 932 through the PCI bus 922. Note that the ASIC 906 may be connected to a USB interface or an Institute of Electrical and Electronics Engineers 1394 (IEEE 1394) interface.

The MEM-C 907 is a local memory used as a copy image buffer and a code buffer. The HD 909 is a storage for accumulating image data, accumulating font data used at the time of printing, and accumulating forms. The HDD controller 908 is a controller that controls reading or writing of data with respect to the HD 909 under the control of the CPU 901. Note that the HDD controller 908 and the HD 909 may be solid state drives (SSDs).

The AGP bus 921 is a bus interface for a graphic accelerator card, which has been proposed to accelerate graphic processing. Through directly accessing the MEM-P 902 by high-throughput, speed of the graphics accelerator card is improved.

The short-range communication circuit 920 is a communication circuit such as Near Field Communication (NFC) or BLUETOOTH (registered trademark). The short-range communication circuit 920 is electrically coupled to ASIC 906 through PCI bus 922. An antenna 920a for wireless communication is connected to the short-range communication circuit 920.

The engine controller 930 includes a scanner 931 and a printer 932. The scanner 931 and printer 932 include image processing functions such as error diffusion or gamma conversion.

The control panel 940 includes a display panel 940a such as a touch panel that displays the current setting value, selection screen, and the like and receives input from the user. Also, the control panel 940 is provided with an operation panel 940b including a numeric keypad for receiving set values of conditions related to image formation such as density setting conditions and a start key for receiving copy start instructions.

Note that the device 30 can switch and select a document box function, a copy function, a print function, and a facsimile function in sequence using the application switching key on the control panel 940. The document box mode is set when the document box function is selected, the copy mode is set when the copy function is selected, the printer mode is set when the printer function is selected, and the facsimile mode is set when the facsimile function is selected.

The network I/F 950 is an interface for data communication through the network N, and is an interface capable of communication conforming to, for example, ETHERNET (registered trademark) and Transmission Control Protocol/Intemet Protocol (TCP/IP) and the like. The network I/F 950 is electrically connected to the ASIC 906 through the PCI bus 922.

Note that the hardware configuration of the information processing apparatus that implements the device 30 illustrated in FIG. 3 is an example, and may not include all the components illustrated in FIG. 3, or may include other components.

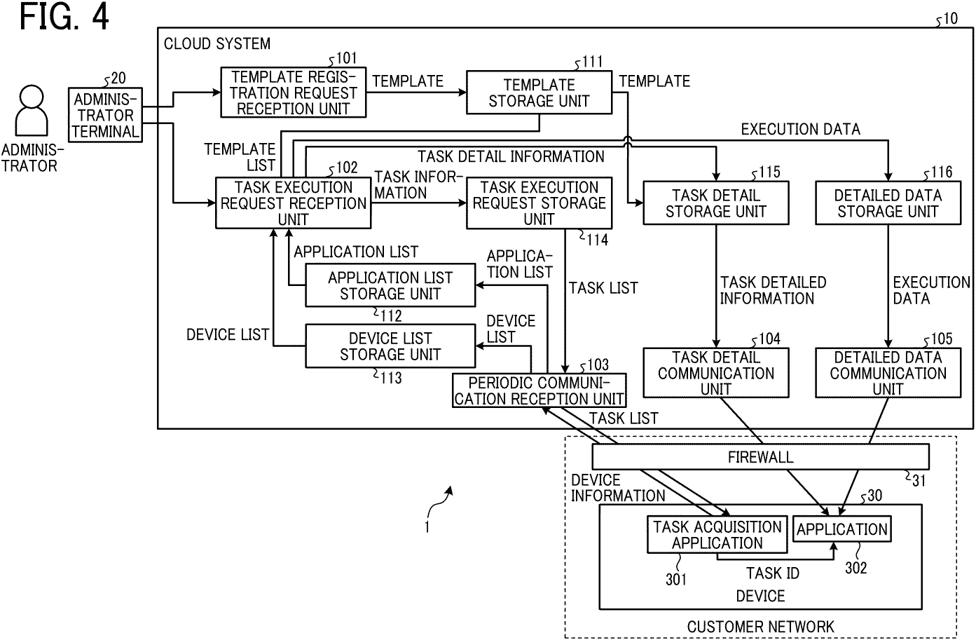

FIG. 4 is a block diagram illustrating an example of a functional configuration of the device management system according to the first embodiment of the present disclosure. The functional configuration and operation of the device management system 1 according to the present embodiment is described with reference to FIG. 4.

As illustrated in FIG. 4, the administrator terminal 20 receives an administrator’s operation, requests creation of a task template for each application of each device 30 within the customer network to be managed, and requests the execution of the task. The task is a process that each application is requested to execute. The template is data that defines which application of which device 30 is to execute what task (for example, device setting change, firmware update, reboot processing, certificate update, installation or uninstallation of an application, etc.). As a result, one template can be applied to a plurality of devices 30, and settings can be made for the plurality of devices 30 collectively.

The administrator terminal 20 selects which application of which device 30 the created template is to be applied to, according to the operation of the administrator. The task is generated by this operation, and the device 30 starts executing the task at the timing of next polling communication of a task acquisition application 301 of the device 30, which is described below.

As illustrated in FIG. 4, the device 30 includes a task acquisition application 301 (acquisition unit) and one or more applications 302.

The task acquisition application 301 periodically communicates with the cloud system 10 by polling, and transmits to the cloud system 10, device information including information on each device 30 in the customer network and information on the applications installed in each device 30. In addition, the task acquisition application 301, acquires as a response from the cloud system 10, a list of tasks that each application (application 302) of the device 30 is requested to execute on behalf of each application installed in the device 30. For example, the task acquisition application 301 acquires as information related to the task, a task ID that identifies the task to be executed by the device 30 and an application ID that identifies the application 302 that is requested to execute the task. Then, when there is a task to be executed by the device 30, the task acquisition application 301 distributes the task in the list to each application 302 identified by the application ID (notifies the task ID).

The application 302 is an application that acquires task detail information from the cloud system 10 based on the task ID of the task assigned by the task acquisition application 301 and executes the task using the task detail information. In the case the application 302 is to use execution data to execute a task, that is, in the case the task detail information includes a uniform resource locator (URL) of the execution data, the application 302 downloads the execution data from the cloud system 10 based on the URL. That is, the application 302 normally executes a task based on the task detail information, but downloads and uses the execution data in the case the execution data is to be used for executing the task. As a result, the amount of communication between the device 30 and the cloud system 10 is reduced, and cost can be reduced by using an inexpensive communication network with a small bandwidth. The application 302 then notifies the cloud system 10 of a task execution result. The task detail information is information indicating contents of the task, and includes, for example, a type of task and setting values used for executing the task. Here, the task detail information may include information identifying execution data or information indicating a storage destination for storing the execution data. The execution data is data used to execute the task indicated by the task ID, and includes files, programs, and the like. Since the execution data is larger in capacity than the task detail information, the execution data may be expressed as large capacity data.

As illustrated in FIG. 4, the cloud system 10 includes a template registration request reception unit 101, a task execution request reception unit 102 (an example of a first registration unit), a periodic communication reception unit 103, a task detail communication unit 104 (first transmission unit), a detailed data communication unit 105 (second transmission unit), a template storage unit 111, an application list storage unit 112, a device list storage unit 113. a task execution request storage unit 114 (first storage unit), a task detail storage unit 115 and a detailed data storage unit 116.

The template registration request reception unit 101 is a functional unit that receives a template creation request from the administrator terminal 20, creates a template in response to the template creation request, and stores the template in the template storage unit 111.

The task execution request reception unit 102 is a functional unit that receives a task execution request from the administrator terminal 20 and stores the task execution request in the task execution request storage unit 114. The task execution request includes at least a task ID that identifies the task, a device ID that identifies the device 30. an application ID that identifies the application 302, and a task type (contents of the task). Further, the task execution request reception unit 102 stores task detail information in the task detail storage unit 115 based on the received task execution request. The task detail information includes at least the task ID, a template ID for identifying the template, device setting item and setting value, the URL of execution data when applicable, and a status. Further, when the execution data is to be used to execute a task included in the received task execution request, the task execution request reception unit 102 stores the task ID and execution data of the task in the detailed data storage unit 116.

The periodic communication reception unit 103 is a functional unit that receives the device information from the task acquisition application 301 through periodic polling communication, updates the list of devices in the device list storage unit 113 and the list of applications in the application list storage unit 112, and when there is a list of tasks related to the task execution request for the device 30, transmits the list of the tasks to the task acquisition application 301.

The task detail communication unit 104 is a functional unit that reads the task detail information of the task ID included in the request from the task detail storage unit 115, includes the template in the task detail information, and transmits to the application 302 in response to a request from the application 302.

In the case the task detail information acquired by the application 302 includes a URL for the execution data, the detailed data communication unit 105 is a functional part that reads the execution data from the storage area of the detailed data storage unit 116 indicated by the URL and transmits the execution data to the application 302.

The template storage unit 111 is a functional unit that stores the template created by the template registration request reception unit 101. The template storage unit 111 is implemented by the HD 804 illustrated in FIG. 2.

The application list storage unit 112 is a functional unit that stores a list of each application installed in each device 30. The application list storage unit 112 is implemented by the HD 804 illustrated in FIG. 2.

The device list storage unit 113 is a functional unit that stores a list of each device 30. The device list storage unit 113 is implemented by the HD 804 illustrated in FIG. 2.

The task execution request storage unit 114 is a functional unit that stores the task execution request received by the task execution request reception unit 102 in the task execution request storage unit 114. In other words, the task execution request storage unit 114 is a functional unit that registers the task. The task execution request storage unit 114 is implemented by the HD 804 illustrated in FIG. 2.

The task detail storage unit 115 is a functional unit that stores the task detail information according to the task execution request received by the task execution request reception unit 102. The task detail storage unit 115 is implemented by the HD 804 illustrated in FIG. 2.

The detailed data storage unit 116 is a functional unit that stores the execution data to be used for executing the task. The detailed data storage unit 116 is implemented by the HD 804 illustrated in FIG. 2.

The template registration request reception unit 101, the task execution request reception unit 102, the periodic communication reception unit 103, the task detail communication unit 104, and the detailed data communication unit 105 are implemented by, for example, the CPU 801 illustrated in FIG. 2 executing a program. Some or all of these functional units may be implemented by integrated circuits such as Field-Programmable Gate Arrays (FPGAs) or ASICs, instead of software programs.

Note that each functional unit of the cloud system 10 illustrated in FIG. 4 conceptually illustrates the function, and is not limited to such a configuration. For example, a plurality of functional units illustrated as independent functional units in the cloud system 10 illustrated in FIG. 4 may be configured as one functional unit. On the other hand, the function of one functional unit in the cloud system 10 illustrated in FIG. 4 may be divided into a plurality of functional units.

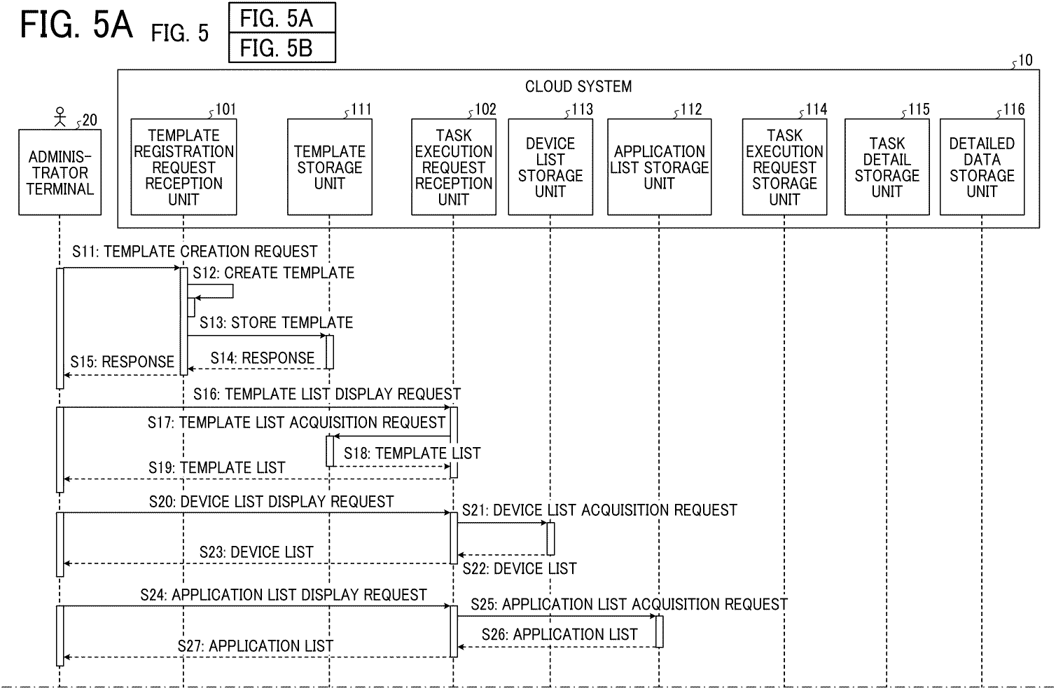

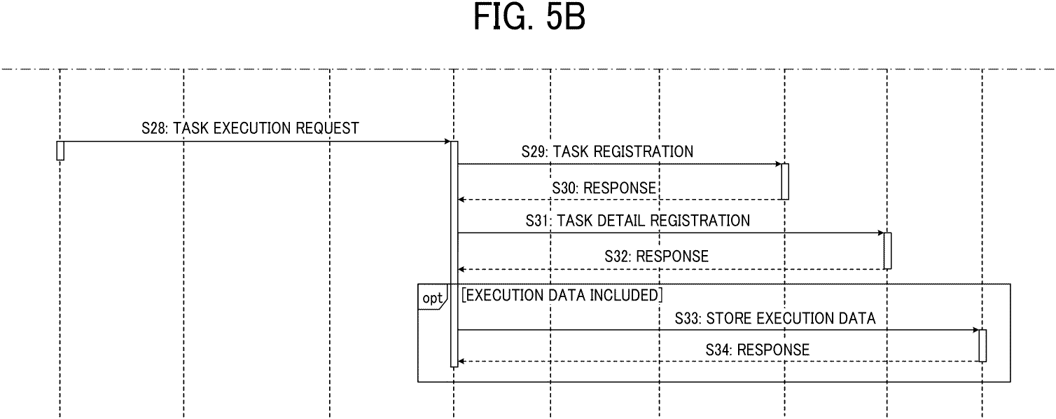

FIGS. 5A and 5B are sequence diagrams illustrating an example of a task registration process executed by the device management system according to the first embodiment of the present disclosure. The task registration process executed by the device management system 1 according to the present embodiment is described with reference to FIGS. 5A and 5B.

In step S11, the administrator terminal 20 receives an operation of the administrator and transmits to the cloud system 10, a task template creation request for requesting each application of each device 30 in the customer network to be managed.

In steps S12 and S13, the template registration request reception unit 101 of the cloud system 10 creates a template in response to the template creation request, and stores (saves) the template in the template storage unit 111. In step S14, the template registration request reception unit 101 receives a template storage completion response from the template storage unit 111.

In step S15, the template registration request reception unit 101 transmits a response to the administrator terminal 20 indicating that the template is created and stored.

In step S16, the administrator terminal 20 transmits a template list display request to the cloud system 10 according to an operation by the administrator.

In steps S17 to S19, the task execution request reception unit 102 of the cloud system 10 acquires the template list from the template storage unit III in response to receiving the template list display request, and transmits the template list to the administrator terminal 20.

In step S20, in response to a selection of a specific template from the template list by the administrator, the administrator terminal 20 issues to the cloud system 10, a device list display request for requesting display of a list of devices for which task execution is set according to the selected template.

In steps S21 to S23, the task execution request reception unit 102 acquires the list of devices 30 from the device list storage unit 113 in response to the device list display request, and transmits the list of devices 30 to the administrator terminal 20.

In step S24, in response to a selection of a specific device 30 from the list of devices 30 by the administrator, the administrator terminal 20 transmits to the cloud system 10, an application list display request for requesting display of a list of applications (applications 302) that can execute tasks on the selected device 30.

In steps S25 to S27, the task execution request reception unit 102 acquires a list of applications (applications 302) in response to the application list display request, and transmits the list of applications to the administrator terminal 20.

In step S28, the administrator terminal 20 transmits to the cloud system 10, a task execution request for the application 302 of the device 30 selected by the administrator’s operation. Note that the number of applications (applications 302) related to the task execution request may be plural.

In steps S29 and S30, the task execution request reception unit 102 receives a task execution request from the administrator terminal 20, stores the task execution request in the task execution request storage unit 114, and receives a response of storage completion of the task execution request from the task execution request storage unit 114.

In steps S31 and S32, the task execution request reception unit 102 stores task detail information in the task detail storage unit 115 based on the received task execution request, and receives a response from the task detail storage unit 115 indicating completion of storage of the task detail information.

In steps S33 and S34, in the case execution data is to be used for execution of the task included in the received task execution request, the task execution request reception unit 102 causes the detailed data storage unit 116 to store the task ID and execution data of the task and a response indicating completion of storage of the execution data is received from the detailed data storage unit 116.

The task registration process of the device management system 1 is executed by steps S11 to S34 described above.

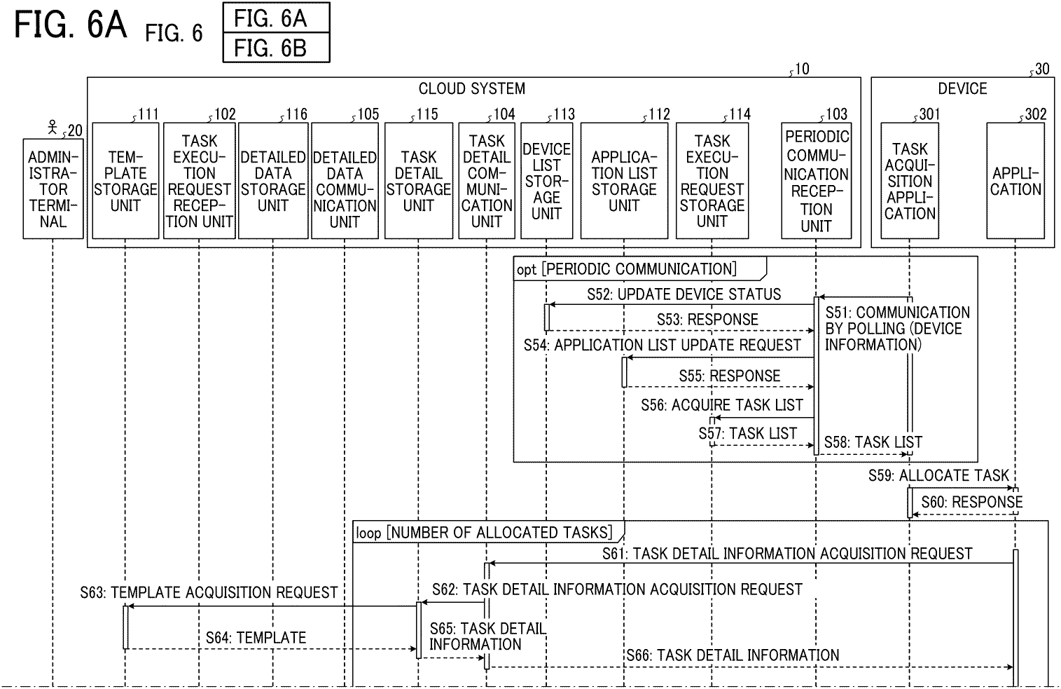

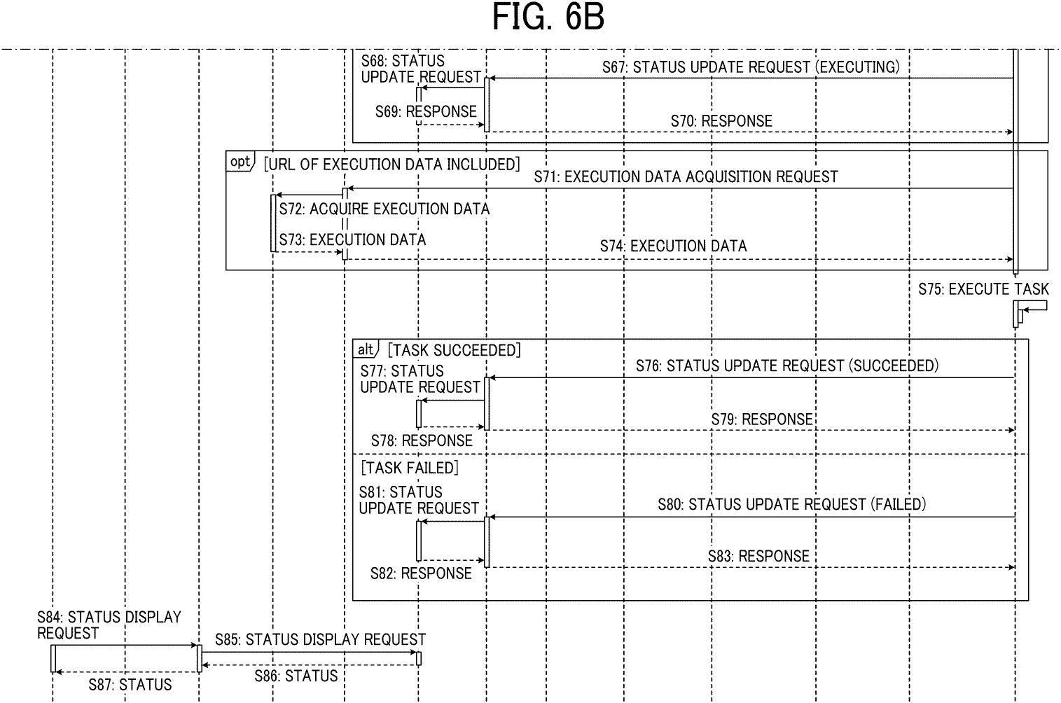

FIGS. 6A and 6B are a sequence diagram illustrating an example of a task execution process executed by the device management system according to the first embodiment of the present disclosure. The task execution process of the device management system 1 according to the present embodiment is described with reference to FIGS. 6A and 6B.

In step S51, the task acquisition application 301 of the device 30 periodically communicates with the cloud system 10 by polling, and transmits to the cloud system 10, the device information including information on each device 30 in the customer network and information on applications installed on each device 30.

In steps S52 and S53, the periodic communication reception unit 103 of the cloud system 10 receives device information through periodic polling communication from the task acquisition application 301, and stores the list of devices (devices 30) in the device list storage unit 113 (for example, including the state of the device 30), and receives an update completion response from the device list storage unit 113.

In steps S54 and S55, the periodic communication reception unit 103 updates the application list in the application list storage unit 112 based on the received device information, and receives an update completion response from the application list storage unit 112.

In the case a list of tasks related to the task execution request is stored in the task execution request storage unit 114 for each application 302 of the device 30, the periodic communication reception unit 103 acquires and transmits the list of tasks to the task acquisition application 301 of the device 30, in steps S56 to S58.

In step S59, the task acquisition application 301 allocates the tasks in the list to each application 302 (notifies the task ID). In step S60. the application 302 responds.

In step S61, the application 302 of the device 30 transmits to the cloud system 10 a task detail information acquisition request requesting task detail information based on the task ID of the task assigned by the task acquisition application 301.

In steps S62 to S65, in response to the task detail information acquisition request from the application 302, the task detail communication unit 104 of the cloud system 10 reads the task detail information of the task ID included in the task detail information acquisition request from the task detail storage unit 115. Further, the task detail communication unit 104 reads from the template storage unit 111 the template corresponding to the template ID included in the task detail information.

In step S66. the task detail communication unit 104 includes the read template in the task detail information and transmits the task detail information to the application 302.

In step S67, the application 302 transmits to the cloud system 10 a status update request for updating the status of the task to “executing”.

In steps S68 and S69, in response to the status update request from the application 302, the task detail communication unit 104 updates the status of the task detail information in the task detail storage unit 115, which is the reading source, to “executing”, and receive an update completion response from the task detail storage unit 115. In step S70. the task detail communication unit 104 transmits the update completion response to the application 302.

In step S71, in the case the execution data is to be used for execution of the task, that is, when the task detail information includes the URL of the execution data, the application 302 transmits an execution data acquisition request for requesting the execution data to the cloud system 10.

In steps S72 to S74, in response to the execution data acquisition request from the application 302, the detailed data communication unit 105 of the cloud system 10 reads the execution data from the detailed data storage unit 116 based on the URL included in the execution data acquisition request. The detailed data communication unit 105 then transmits the execution data to the application 302.

In step S75, the application 302 executes the task assigned by the task acquisition application 301 using the task detail information and, when applicable, the received execution data.

In step S76, following a successful execution of the task by the application 302, the application 302 transmits to the cloud system 10 a status update request for updating the status of the task to “succeeded”.

In steps S77 to S78, in response to the status update request from the application 302, the task detail communication unit 104 updates the status of the task detail information in the task detail storage unit 115, which is the reading source, to “succeeded”, and receive an update completion response from the task detail storage unit 115. In step S79, the task detail communication unit 104 transmits the update completion response to the application 302.

In step S80, following a failure in execution of the task by the application 302, the application 302 transmits to the cloud system 10 a status update request for updating the status of the task to “failed”.

In steps S81 and S82, in response to the status update request from the application 302, the task detail communication unit 104 updates the status of the task detail information in the task detail storage unit 115, which is the reading source, to “failed” and receive an update completion response from the task detail storage unit 115. In step S83, the task detail communication unit 104 transmits the update completion response to the application 302.

In step S84, according to the operation of the administrator, the administrator terminal 20 transmits a status display request for the requested task to the cloud system 10 in order to confirm the execution result of the requested task.

In steps S85 and S86. the task execution request reception unit 102 of the cloud system 10 acquires the status included in the task detail information of the target task from the task detail storage unit 115 in response to the status display request from the administrator terminal 20.

In step S87, the task execution request reception unit 102 transmits the acquired status to the administrator terminal 20. The administrator terminal 20 displays the acquired status.

The task execution process of the device management system 1 is executed by steps S51 to S87 described above.

As described above, in the device management system 1 according to the present embodiment, the task execution request reception unit 102 registers the task in the task execution request storage unit 114 according to the operation of the administrator terminal 20, the task acquisition application 301 periodically acquires one or more tasks registered in the task execution request storage unit 114 and assigns each task to one or more applications 302, the task detail communication unit 104 transmits task detail information to be used for executing the task to the application 302 to which the task has been assigned, and the detailed data communication unit 105 transmits the execution data to be used for executing the task to the application 302 in response to a request from the application 302 to which the task has been assigned. The task acquisition application 301 periodically acquires the list of tasks on behalf of the task list, and separates the transmission of task detail information from the transmission of execution data when applicable. As a result, the amount of communication between the device 30 and the cloud system 10 is reduced, a load on the cloud system 10 when each device 30 acquires a task from the cloud system 10 is reduced, and cost is reduced by using an inexpensive communication network with a small bandwidth for tasks with a small amount of communication.

The device management system according to a second embodiment is described in the following, focusing on the differences from the device management system 1 according to the first embodiment. In this embodiment, an operation of executing a task according to a schedule registered in advance is described. The overall configuration of the device management system according to the present embodiment and the hardware configuration of the cloud system, administrator terminal 20 and device 30 are the same as those described in the first embodiment.

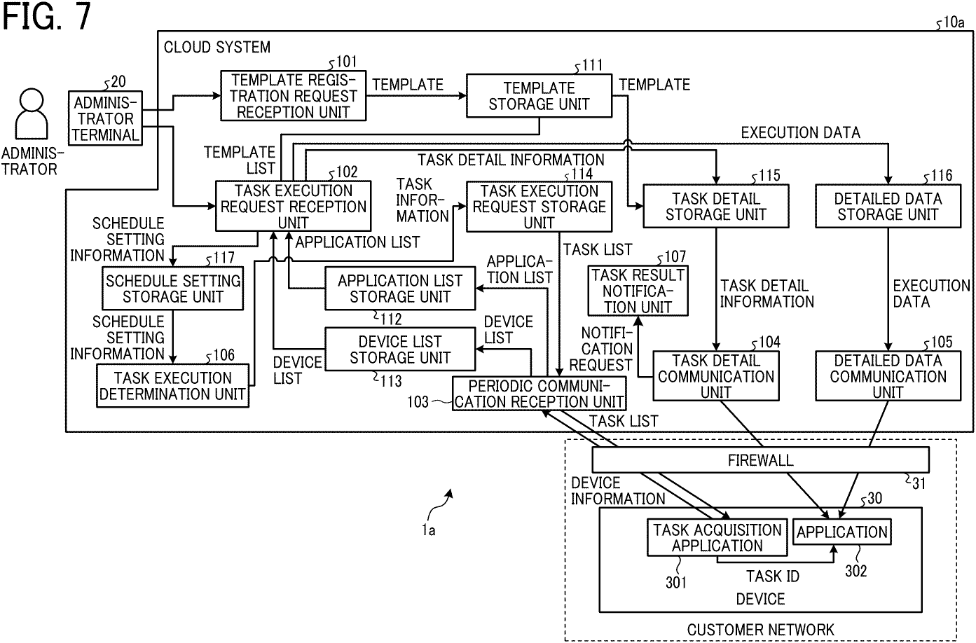

FIG. 7 is a block diagram illustrating an example of a functional configuration of the device management system according to the second embodiment of the present disclosure. The functional configuration and operation of the device management system 1a according to the present embodiment is described with reference to FIG. 7.

As illustrated in FIG. 7, the device management system 1a includes a cloud system 10a. an administrator terminal 20, a device 30 in the customer network, and a firewall 31.

As illustrated in FIG. 7, the cloud system 10a includes a template registration request reception unit 101, a task execution request reception unit 102 (second registration unit), a periodic communication reception unit 103, and a task detail communication unit 104 (an example of first transmission unit and first reception unit), a detailed data communication unit 105 (second transmission unit), a task execution determination unit 106 (an example of a first registration unit, first determination unit), and a task result notification unit 107 (notification unit), a template storage unit 111, an application list storage unit 112, a device list storage unit 113, a task execution request storage unit 114 (first storage unit), a task detail storage unit 115, and a detailed data storage unit 116, and a schedule setting storage unit 117 (second storage unit).

The task execution request reception unit 102 is a functional unit that receives a schedule setting request from the administrator terminal 20 and stores schedule setting information in the schedule setting storage unit 117 according to the schedule setting request. The schedule setting information includes at least a task ID that identifies the task, a device ID that identifies the device 30, an application ID that identifies the application 302, a task type (contents of the task), schedule settings, and task result notification destination. The schedule settings include, for example, a setting to specify the year, month, day, hour and minute to execute the schedule once, setting of a daily schedule by specifying the hour and minute, setting of a weekly schedule by specifying the day of the week, hour and minute, and setting of a monthly schedule by specifying the day, hour, and minute. The task result notification destination is, for example, an e-mail address, cooperation information of a chat system such as Slack, a URL of a Hypertext Transfer Protocol (HTTP) server, or the like. The task execution request reception unit 102 provides the administrator terminal 20 with screen information for the administrator to input schedule settings and task result notification destinations. Further, the task execution request reception unit 102 stores task detail information in the task detail storage unit 115 based on the received schedule setting request. Further, when execution data is to be used to execute the task included in the received schedule setting request, the task execution request reception unit 102 stores the task ID and execution data of the task in the detailed data storage unit 116.

The task execution determination unit 106 is a functional unit that periodically acquires schedule setting information stored in the schedule setting storage unit 117 and compares the schedule setting information with the current time. Based on a determination by the task execution determination unit 106 that the time set in the schedule setting information has passed the current time, the task execution request storage unit 114 stores the schedule setting information as a task execution request.

The task result notification unit 107 is a functional unit that transmits a task execution result to the task result notification destination in response to a notification request from the task detail communication unit 104.

The schedule setting storage unit 117 is a functional unit that stores schedule setting information. The schedule setting storage unit 117 is implemented by the HD 804 illustrated in FIG. 2.

The operations of other functional units of the cloud system 10a are the same as those described in the first embodiment

The template registration request reception unit 101. the task execution request reception unit 102, the periodic communication reception unit 103, the task detail communication unit 104, the detailed data communication unit 105, the task execution determination unit 106, and the task result notification unit 107 described above is implemented by, for example, executing a program by the CPU 801 illustrated in FIG. 2. Some or all of these functional units may be implemented by integrated circuits such as FPGAs or ASICs, instead of the software programs.

Further, each functional unit of the cloud system 10a illustrated in FIG. 7 conceptually represents a function and configuration is not limited to the diagram illustrated in FIG. 7. For example, a plurality of functional units illustrated as independent functional units in the cloud system 10a illustrated in FIG. 7 may be configured as one functional unit. On the other hand, a function of one functional unit in the cloud system 10a illustrated in FIG. 7 may be divided into a plurality of functional units.

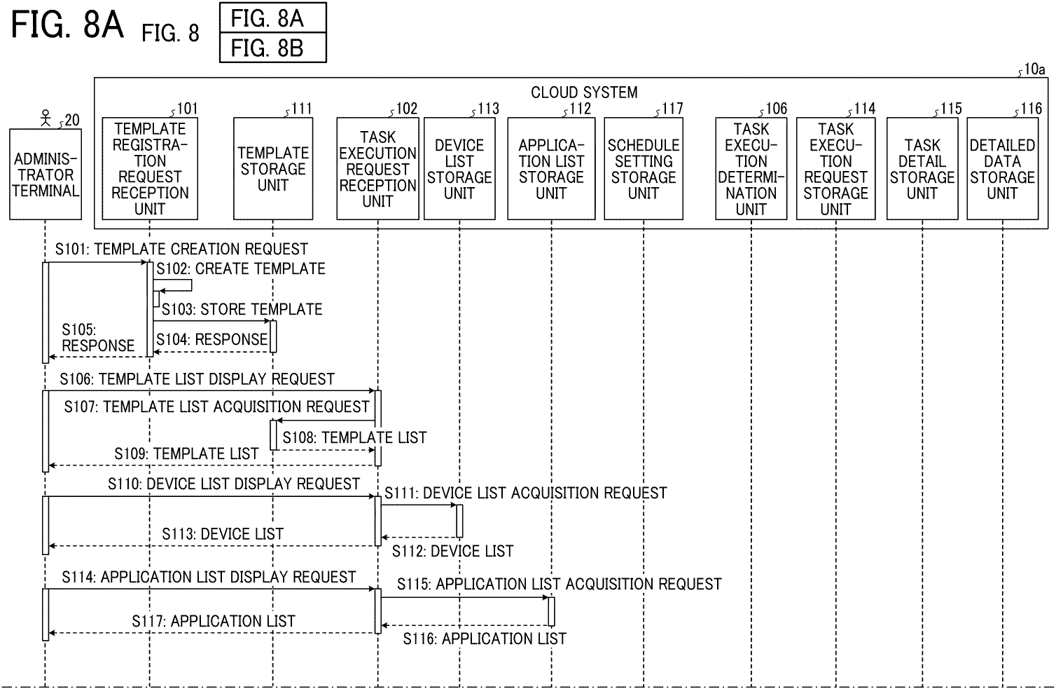

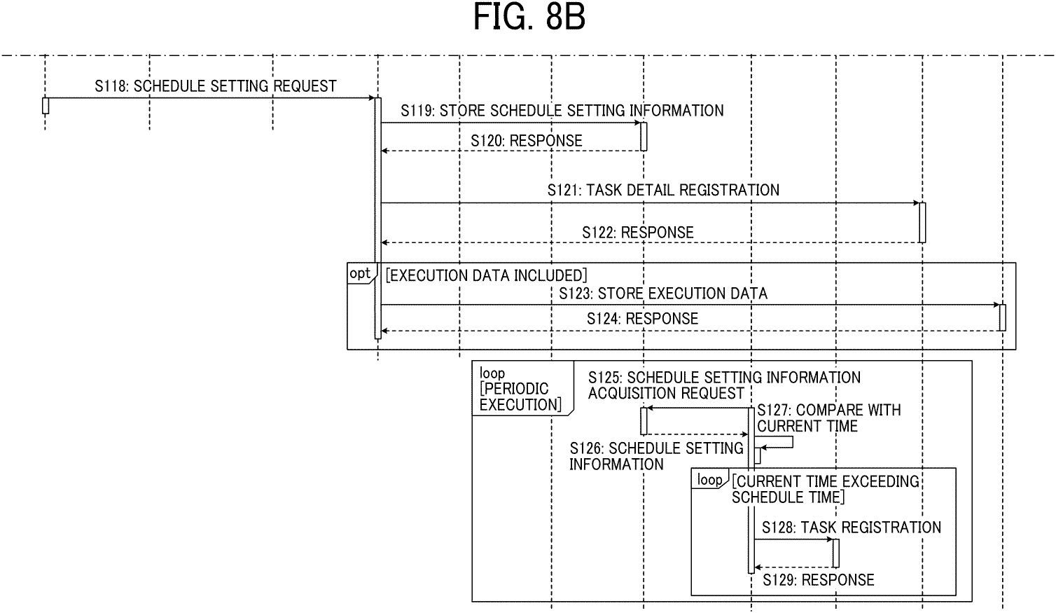

FIGS. 8A and 8B are sequence diagrams illustrating an example of a task registration process executed by the device management system according to the second embodiment of the present disclosure. The task registration process executed by the device management system 1a according to the present embodiment is described with reference to FIGS. 8A and 8B.

The processes of steps S101 to S117 are the same as the processes of steps S11 to S27 in FIG. 5A, respectively.

In step S118, the administrator terminal 20 transmits to the cloud system 10a a schedule setting request for causing the application 302 of the device 30 selected by the administrator’s operation to execute the task according to the schedule. Note that the number of applications (applications 302) related to the schedule setting request may be plural.

In steps S119 and S120, the task execution request reception unit 102 receives the schedule setting request from the administrator terminal 20. stores the schedule setting information in the schedule setting storage unit 117 according to the schedule setting request, and receives from the schedule setting storage unit 117, a storage completion response of the schedule setting information.

In steps S121 and S122, the task execution request reception unit 102 stores the task detail information in the task detail storage unit 115 based on the received schedule setting request, and receives a response from the task detail storage unit 115 indicating completion of storage of the task execution request.

In steps S123 and S124, in the case the execution data is to be used to execute the task included in the received schedule setting request, the task execution request reception unit 102 causes the detailed data storage unit 116 to store the task ID and the execution data of the task, and receives from the detailed data storage unit 116. a storage completion response of the execution data.

In steps S125 and S126, the task execution determination unit 106 of the cloud system 10a periodically acquires the schedule setting information stored in the schedule setting storage unit 117.

In step S127, the task execution determination unit 106 compares the time set in the acquired schedule setting information with the current time.

In steps S128 and S129, based on a determination by the task execution determination unit 106 that the current time has passed the time set in the schedule setting information, the task execution determination unit 106 stores the schedule setting information as a task execution request in the task execution request storage unit 114, and a storage completion response of the task execution request is received from the task execution request storage unit 114.

The task registration process of the device management system 1a is executed by the steps S101 to S129 described above.

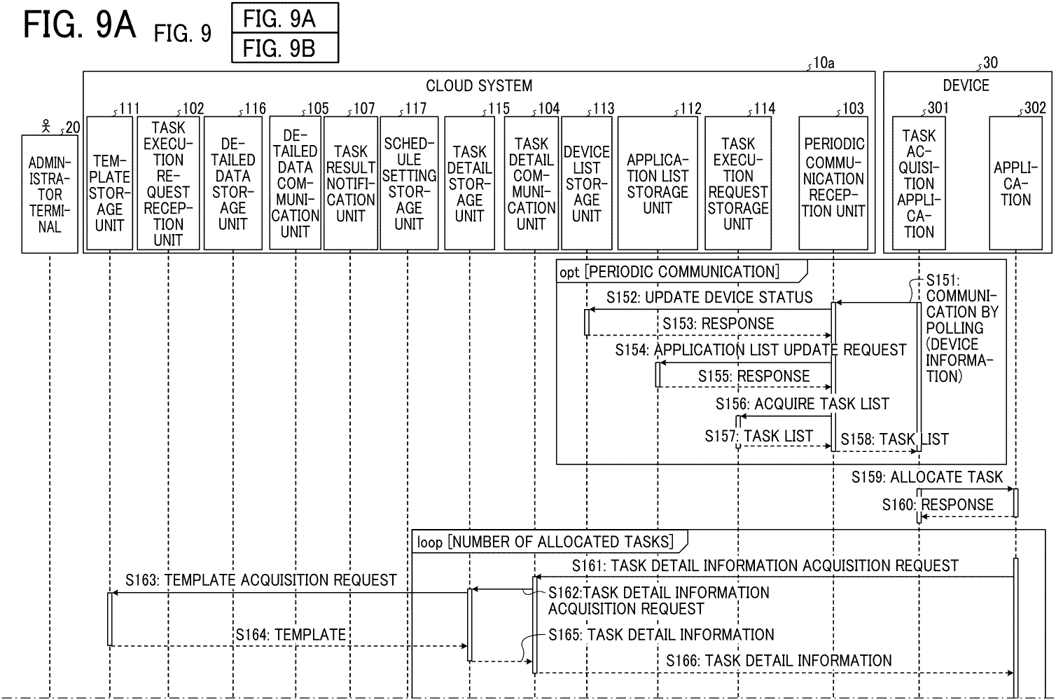

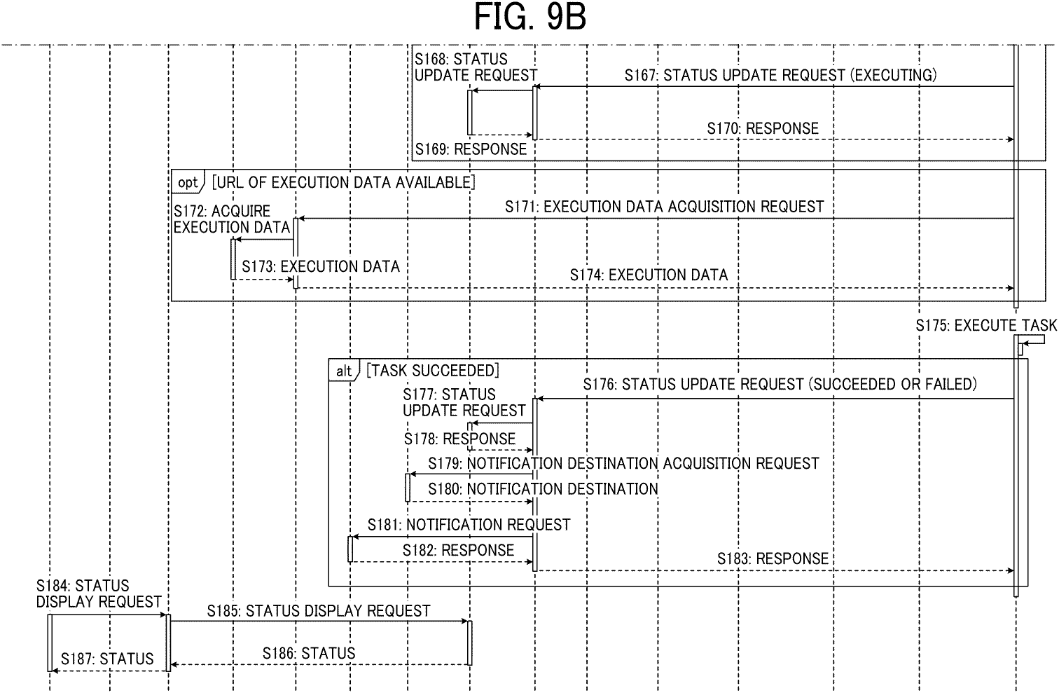

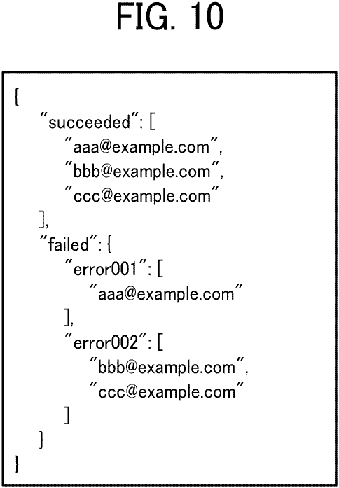

FIGS. 9A and 9B are sequence diagrams illustrating an example of the task execution process executed by the device management system according to the second embodiment of the present disclosure. FIG. 10 is a diagram illustrating an example of data structure of notification destination information. The task registration process executed by the device management system 1a according to the present embodiment is described with reference to FIGS. 9A, 9B and 10.

The processes of steps S151 to S175 are the same as the processes of steps S51 to S75 in FIGS. 6A and 6B, respectively.

In step S176, the application 302 transmits to the cloud system 10a a status update request for updating the status of the task to “succeeded” or “failed”.

In steps S177 and S178, in response to the status update request from the application 302, the task detail communication unit 104 updates the status of the task detail information in the task detail storage unit 115, which is the reading source, to “succeeded” or “failed” and receives an update completion response from the task detail storage unit 115.

In steps S179 and S180, the task detail communication unit 104 acquires the task result notification destination from the schedule setting information stored in the schedule setting storage unit 117 that corresponds to the task related to the status update request from the application 302. Note that the task detail communication unit 104 may acquire the task result notification destination from the task execution request stored in the task execution request storage unit 114 corresponding to the task related to the status update request from the application 302.

In steps S181 and S182, the task detail communication unit 104 sends a notification request requesting notification of the task execution result to the task result notification unit 107 together with the task result notification destination. An example of the task result notification destination (notification destination information) is illustrated in FIG. 10. In the notification destination information illustrated in FIG. 10, for a successful (“succeeded”) task execution result, the execution result is notified to three e-mail addresses, and for a failure (“failed”) task execution result, when the error content is error code “error001”, notification is sent to one predetermined email address, and when the error content is the error code “error002”, notification is sent to two predetermined e-mail addresses.

The notification destination information is information indicating the destination of notification according to the success or failure of the task and the details of the failure of the task. In the case a task failed, the notification destination is changed according to the error content. For example, when the task failed for a temporary reason, the system operator is notified, and when the cause is thought to be a fatal system problem, the system developer is also notified. A flexible notification operation such as above can be implemented according to the content of the error. In response to a notification request from the task detail communication unit 104. the task result notification unit 107 transmits the task execution result to the task result notification destination according to the task execution result, and sends a notification completion response indicating completion of the notification to the task detail communication unit 104.

In step S183, the task detail communication unit 104 transmits the notification completion response to the application 302.

The processing of steps S184 to S187 is the same as the processing of steps S84 to S87 in FIG. 6B, respectively.

The task execution processing of the device management system 1a is executed according to steps S151 to S187 described above.

As described above, in the device management system 1a according to the present embodiment, the task execution request reception unit 102 registers schedule setting information in which a task schedule is set in the schedule setting storage unit 117 in response to an operation from the administrator terminal 20, the task execution determination unit 106 determines whether the current time has passed the schedule time of the schedule setting information registered in the schedule setting storage unit 117, and based on a determination that the current time has passed the time of the schedule in the schedule setting information, the task corresponding to the schedule setting information is registered in the task execution request storage unit 114. As a result, in addition to the same effect as the first embodiment, tasks can be executed according to the schedule.

Further, in the device management system 1a according to the present embodiment, the task execution request reception unit 102 registers the notification destination information of the task execution result in the schedule setting storage unit 117 according to the operation on the administrator terminal 20, the task detail communication unit 104 receives the execution result of the task from the application 302, and the task result notification unit 107 notifies the notification destination indicated by the notification destination information corresponding to the task registered in the schedule setting storage unit 117 of the execution result of the task received by the task detail communication unit 104. Accordingly, the task execution result is notified to a person to be notified.

The device management system according to a third embodiment is described in the following, focusing on differences from the device management system 1 according to the first embodiment. In this embodiment, an operation of automatically performing a retry operation in response to an interruption of a task execution for some reason (for example, power off or power failure) is described. The overall configuration of the device management system according to the present embodiment and the hardware configuration of the cloud system, administrator terminal 20 and device are the same as those described in the first embodiment

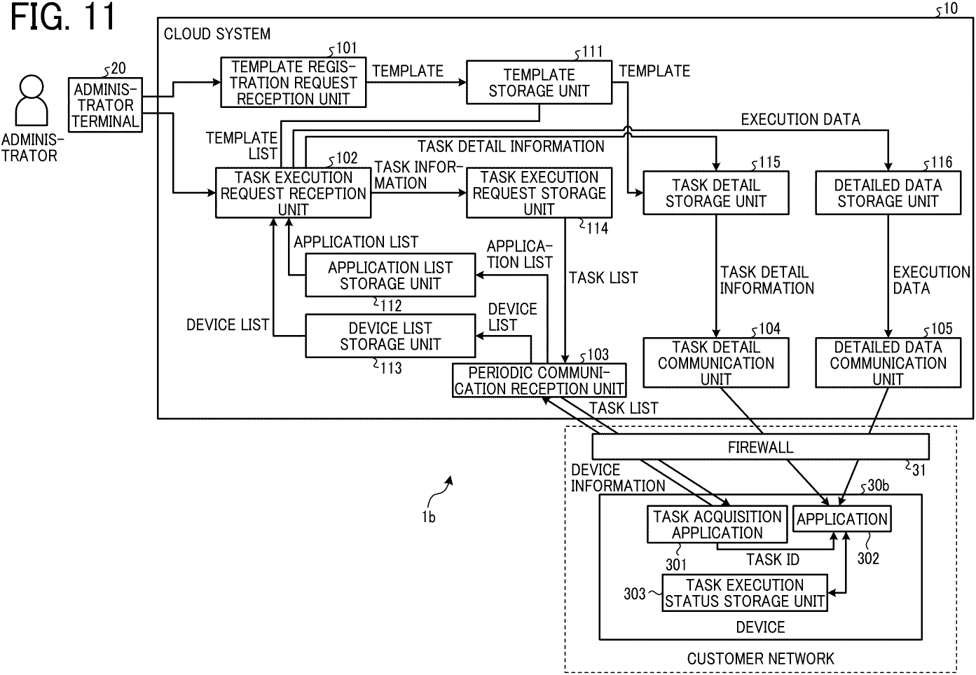

FIG. 11 is a block diagram illustrating an example of a functional configuration of the device management system according to the third embodiment of the present disclosure. The functional configuration and operation of the device management system 1b according to the present embodiment is described with reference to FIG. 11.

As illustrated in FIG. 11, the device management system 1b includes a cloud system 10, an administrator terminal 20, a device 30b in a customer network, and a firewall 31.

As illustrated in FIG. 11, the device 30b includes a task acquisition application 301 (acquisition unit), one or more applications 302, and a task execution status storage unit 303 (an example of a third storage unit).

In addition to the above-described operation, the application 302 causes the task execution status storage unit 303 to store “started” as the execution status of the task together with the task ID in response to a start of the execution of the task. In addition, in response to a completion of the execution of the task, the application 302 causes the task execution status storage unit 303 to store “completed” as the task execution status together with the task ID. Then, in response to a start of the application 302, the application 302 refers to the task execution status storage unit 303 and re-executes the task corresponding to the task ID for which “started” is stored.

The task execution status storage unit 303 is a functional unit that stores the execution status (“started” or “completed”) of each task together with the task ID of the task. The task execution status storage unit 303 is implemented by the HD 909 illustrated in FIG. 3.

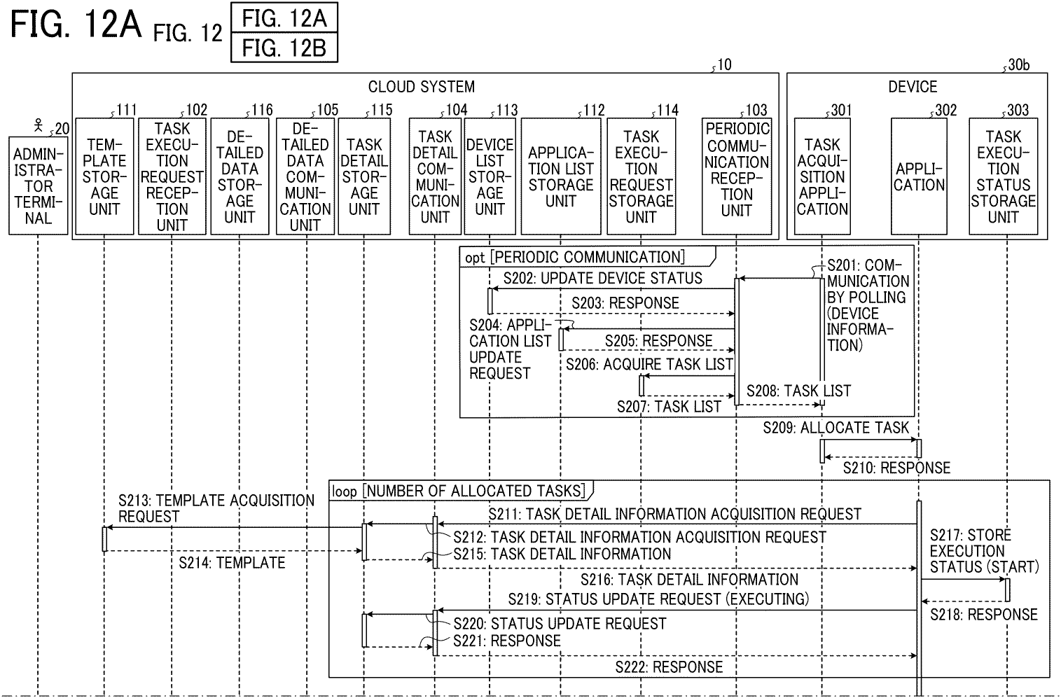

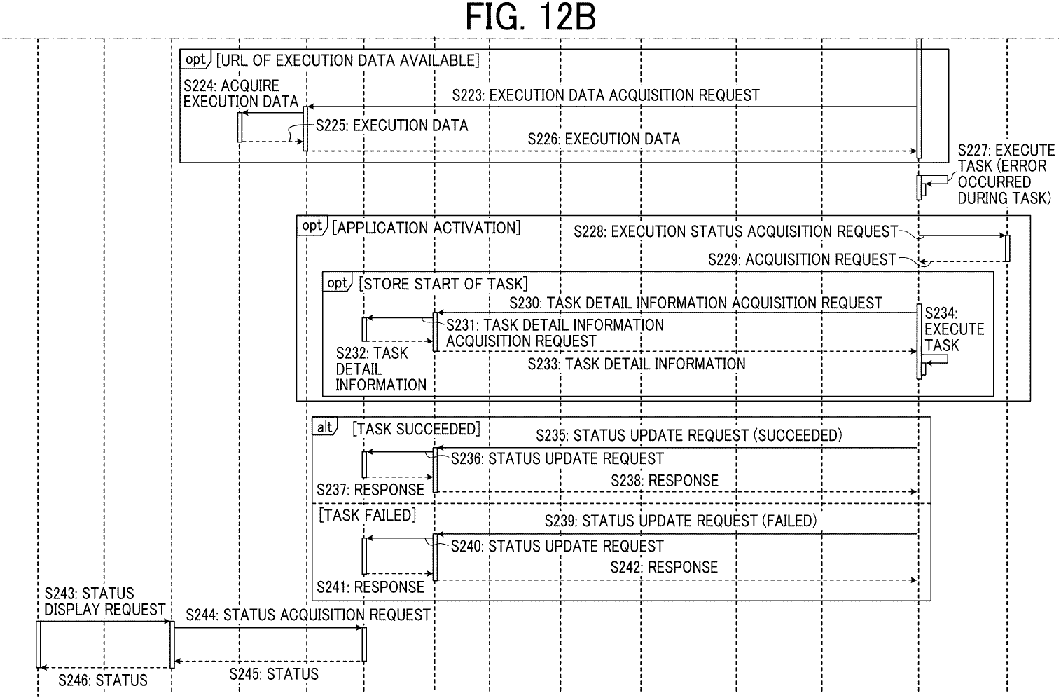

FIGS. 12A and 12B are sequence diagrams illustrating an example of the task execution process executed by the device management system according to the third embodiment of the present disclosure. The task execution process executed by the device management system 1b according to the present embodiment is described with reference to FIGS. 12A and 12B.

The processes of steps S201 to S216 are the same as the processes of steps S51 to S66 in FIG. 6A, respectively.

In steps S217 and S2 18, the application 302 of the device 30b causes the task execution status storage unit 303 to store “started” as the task execution status together with the task ID, and receives a storage completion response from the task execution status storage unit 303.

The processes of steps S219 to S226 are the same as the processes of steps S67 to S74 in FIG. 6B, respectively.

In step S227, the application 302 executes the task assigned by the task acquisition application 301 using the received task detail information and, when applicable, the received execution data. The following description is based on an assumption that execution of the task by the application 302 is interrupted due to some kind of failure (for example, power off or power failure).

In steps S228 and S229, in response to a start of the application 302, the application 302 refers to the task execution status storage unit 303 and acquires the execution status of the task of the task ID related to the execution of the application 302.

In step S230, in the case the acquired execution status is “started”, the application 302 transmits a task detail information acquisition request for requesting task detail information to the cloud system 10 based on the task ID of the corresponding task.

In steps S231 and S232, in response to the task detail information acquisition request from the application 302, the task detail communication unit 104 of the cloud system 10 reads the task detail information of the task ID included in the task detail information acquisition request from the task detail storage unit 115.

In step S233, the task detail communication unit 104 transmits the task detail information to the application 302.

In step S234, the application 302 uses the received task detail information to re-execute the interrupted task.

In response to a completion of the execution of the task, the application 302 causes the task execution status storage unit 303 to store “completed” as the task execution status in association with the task ID.

The processes of steps S235 to S246 are the same as the processes of steps S76 to S87 in FIG. 6B, respectively.

The task execution process of the device management system 1b is executed by steps S201 to S246 described above.

As described above, in the device management system 1b according to the present embodiment, the application 302 causes the task execution status storage unit 303 to store the execution status indicating that the task is started in response to a start of execution of the task, in response to a completion of the execution of the task, the task execution status storage unit 303 stores the execution status indicating completion of the task, and in the case there is a task whose execution status is “started” in the task execution status storage unit 303 at startup, the task is re-executed. As a result, in addition to the same effect as the first embodiment described above, in the case a task is interrupted for some reason, the data is re-acquired, and the task is re-executed.

The device management system according to a fourth embodiment is described in the following, focusing on the differences from the device management system 1 according to the first embodiment. In this embodiment, the operation of determining whether a task can be executed according to a load state of the cloud system is described. The overall configuration of the device management system according to the present embodiment and the hardware configuration of the cloud system, administrator terminal 20 and device 30 are the same as those described in the first embodiment

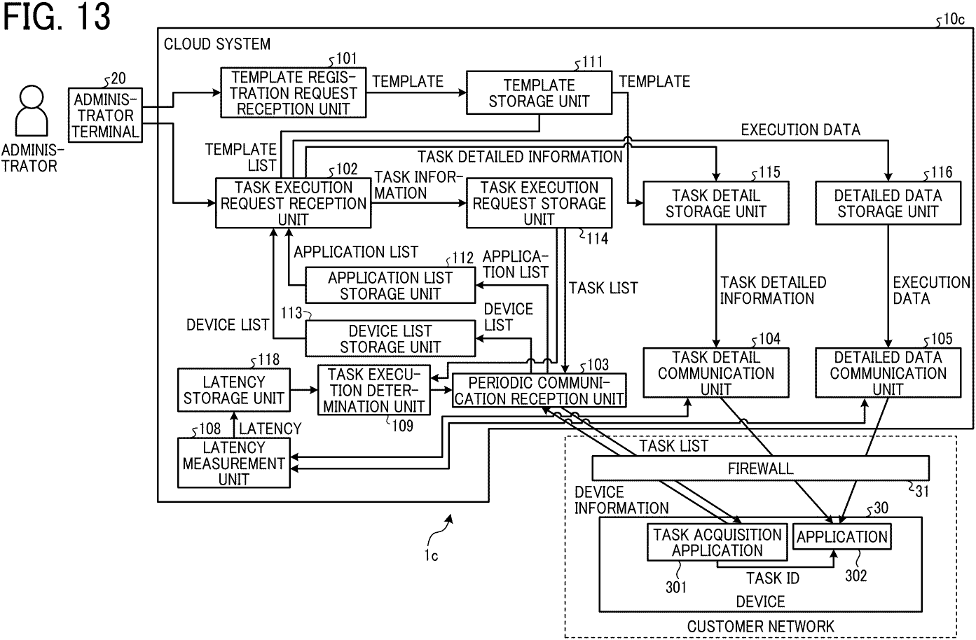

FIG. 13 is a block diagram illustrating an example of a functional configuration of the device management system according to the fourth embodiment of the present disclosure. The functional configuration and operation of the device management system 1c according to the present embodiment are described with reference to FIG. 13.

As illustrated in FIG. 13, the device management system 1c includes a cloud system 10c, an administrator terminal 20, a device 30 in a customer network, and a firewall 31.

As illustrated in FIG. 7, the cloud system 10c includes a template registration request reception unit 101, a task execution request reception unit 102 (an example of a first registration unit), a periodic communication reception unit 103, a task detail communication unit 104 (first transmission unit), a detailed data communication unit 105 (second transmission unit), a latency measurement unit 108 (measurement unit), a task execution determination unit 109 (second determination unit), a template storage unit 111, an application list storage unit 112, a device list storage unit 113, a task execution request storage unit 114 (first storage unit), a task detail storage unit 115, a detailed data storage unit 116, and a latency storage unit 118.

The latency measurement unit 108 is a functional unit that measures latency of the task detail communication unit 104 and the detailed data communication unit 105 and stores the latency in the latency storage unit 118. The latency measurement unit 108 measures the latency using for example, a ping of Internet Control Message Protocol (ICMP).

The task execution determination unit 109 is a functional unit that determines task executability based on the latency of the task detail communication unit 104 and the detailed data communication unit 105 stored in the latency storage unit 118. Table 1 illustrates the determination rule of the task execution determination unit 109 for task executability determination.

TABLE 1

| | | | | |
|---|---|---|---|---|
| Rule Type | Data Type | Sampling method | Comparison operator | Threshold |
| Disallow execution of task | Task detail information | Latest | Larger than | XXX ms |
| | Execution data | Average of past | Equal to or | YYY ms |
| Allow execution of task | Task detail information | Average of past 50 data | Less than | ZZZ ms |
| | Execution data | Average of past 3 hours | Equal to or less than | WWW ms |

For example, the task execution determination unit 109 determines not to execute the task based on a determination that latest latency of the task detail communication unit 104 is greater than XXX ms and the average latency of the detailed data communication unit 105 over the past 24 hours is YYY ms. In another example, the task execution determination unit 109 determines not to execute the task based on a determination that the latest latency of the task detail communication unit 104 is greater than XXX ms or the average latency of the detailed data communication unit 105 over the past 24 hours is YYY ms. Further, the task execution determination unit 109 determines that the task can be executed based on a determination that the average of the past 50 measurements of latency of the task detail communication unit 104 is smaller than ZZZ ms and the average of the past 3 hours of latency of the detailed data communication unit 105 is WWW ms or less. In another example, the task execution determination unit 109 determines that the task can be executed based on a determination that the average of the past 50 measurements of latency of the task detail communication unit 104 is smaller than ZZZ ms or the average of the past 3 hours of latency of the detailed data communication unit 105 is WWW ms or less.

The latency storage unit 118 is a functional unit that stores the latency of the task detail communication unit 104 and the detailed data communication unit 105. The latency storage unit 118 is implemented by the HD 804 illustrated in FIG. 2.

The template registration request reception unit 101, the task execution request reception unit 102, the periodic communication reception unit 103, the task detail communication unit 104, the detailed data communication unit 105, the latency measurement unit 108, and the task execution determination unit 109 described above are implemented by, for example, the CPU 801 illustrated in FIG. 2 executing a program. Note that some or all of these functional units may be implemented by the integrated circuits such as FPGAs or ASICs, instead of the software programs.

Further, each functional unit of the cloud system 10c illustrated in FIG. 13 conceptually represents a function and the configuration is not limited to the diagram illustrated in FIG. 7. For example, a plurality of functional units illustrated as independent functional units in the cloud system 10c illustrated in FIG. 13 may be configured as one functional unit. On the other hand, the function of one functional unit in the cloud system 10 illustrated in FIG. 13 may be divided into a plurality of functional units.

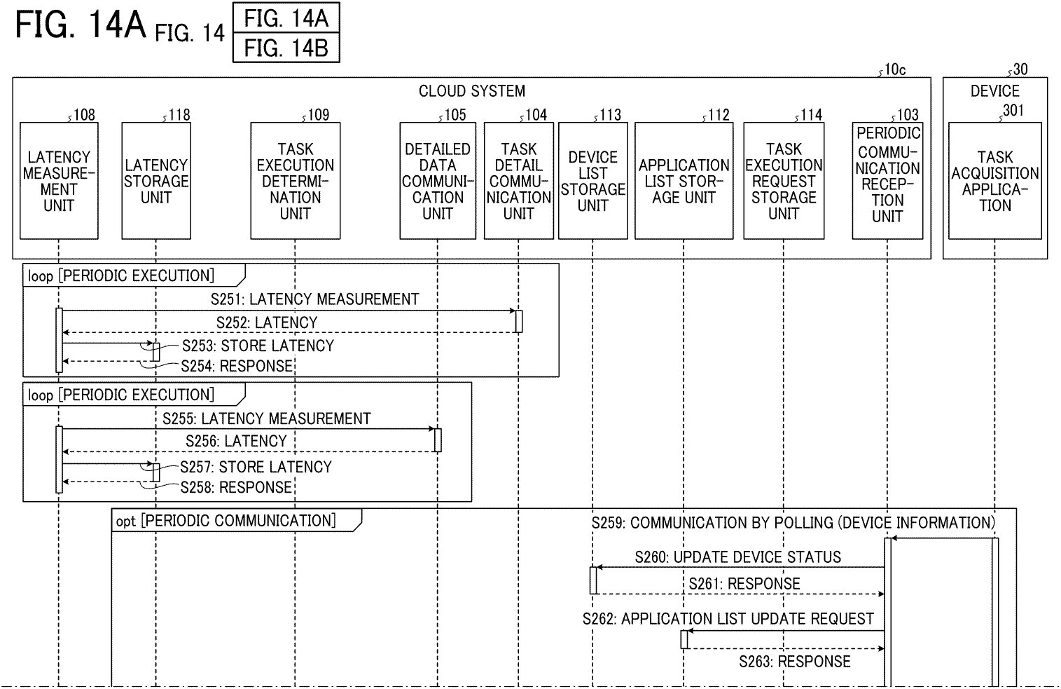

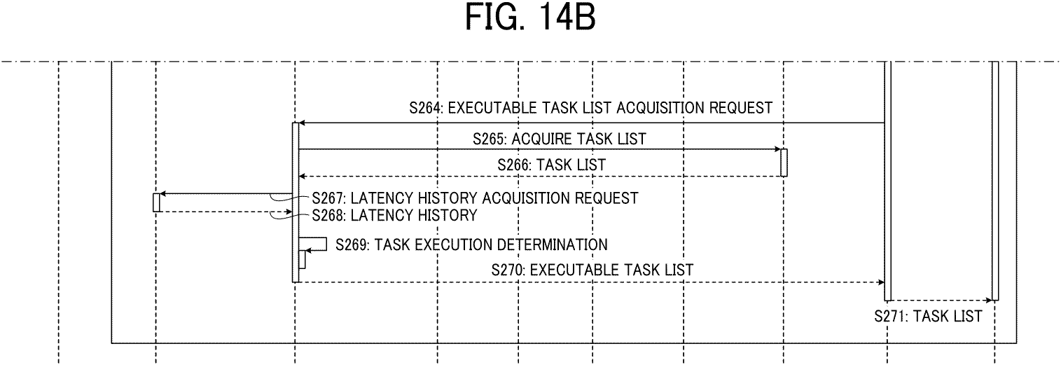

FIGS. 14A and 14B are sequence diagrams illustrating an example of a task execution determination process in the task execution process executed by the device management system according to the fourth embodiment of the present disclosure. The task execution process executed by the device management system 1c is described with reference to FIGS. 14A and 14B.

In steps S251 to S254, the latency measurement unit 108 of the cloud system 10c measures the latency of the task detail communication unit 104 and stores measurement results in the latency storage unit 118.

In steps S255 to S258 the latency measurement unit 108 of the cloud system 10c measures the latency of the detailed data communication unit 105 and stores the measurement result in the latency storage unit 118.

The processes of steps S259 to S263 are the same as the processes of steps S51 to S55 in FIG. 6A, respectively.

In step S264, the periodic communication reception unit 103 of the cloud system 10c sends an executable task list acquisition request for requesting a list of executable tasks to the task execution determination unit 109.

In steps S265 and S266, in the case a list of tasks related to the task execution request is stored in the task execution request storage unit 114 for each application 302 of the device 30, the task execution determination unit 109 acquires the list of tasks.

In steps S267 and S268, the task execution determination unit 109 acquires latency histories of the task detail communication unit 104 and the detailed data communication unit 105 stored in the latency storage unit 118.

In step S269, the task execution determination unit 109 determines execution of each task in the acquired list based on the history of latency using, for example, Table 1 described above.

In steps S270 and S271, the task execution determination unit 109 sends a list of tasks determined to be executable to the periodic communication reception unit 103, and the periodic communication reception unit 103 sends the list to the task acquisition application 301 of the device 30.

Note that the rest of the task execution process is the same as the process described with reference to FIGS. 6A and 6B.

As described above, in the device management system 1c according to the present embodiment, the latency measurement unit 108 measures the latency of the task detail communication unit 104 and the detailed data communication unit 105. stores the measurement result in the latency storage unit 118, the task execution determination unit 109 determines whether the latency stored in the latency storage unit 118 satisfies a predetermined condition, and the task acquisition application 301 acquires one or more tasks based on a determination by the task execution determination unit 109 that the predetermined condition is satisfied. In addition to having the same effect as the above-described first embodiment, in the case the performance of the task detail communication unit 104 and the detailed data communication unit 105 is degraded, transmission of task can be avoided, and the load on the cloud system 10 can be reduced.

Note that each of the above-mentioned embodiment may be combined and applied.

Further, in each of the above-described embodiments, when at least one of the functional units of the cloud systems 10, 10a, 10b, and 10c and the devices 30 and 30b is implemented by executing a program, the program is pre-installed and provided in a ROM or the like. In each of the above-described embodiments, the programs executed by the cloud systems 10, 10a. 10b, and 10c and the devices 30 and 30b are stored as installable or executable files on a CD-ROM, a flexible disk (FD), CD-R, DVD, or other computer-readable recording medium. Further, in each of the above-described embodiments, the programs executed by the cloud systems 10. 10a, 10b. and 10c and the devices 30 and 30b may be configured to be stored on a computer connected to a network such as the internet, and provided by being downloaded through the network. Further, in each of the above-described embodiments, the programs executed by the cloud systems 10, 10a, 10b, and 10c and the devices 30, and 30b may be configured to be provided or distributed through the network such as the internet. Further, in each of the above-described embodiments, the programs executed by the cloud systems 10, 10a, 10b, and 10c and the devices 30 and 30b have a module configuration including at least one of the above-described functional units. As software, the CPU reads and executes the program from the above-described storage device, so that each of the above-described functional units is loaded onto the main storage device and generated. As actual hardware, the CPU reads and executes the program from the above-described storage device, thereby loading and generating each of the above-described functional units onto the main storage device.

Aspects of the present disclosure are, for example, as follows.

According to a first aspect, an information processing system includes a cloud system and one or more devices for executing tasks, the cloud system includes a first registration unit for storing the task in a first storage unit in response to an operation from an administrator terminal, and one or more devices include an acquisition unit for acquiring one or more tasks registered in the first storage unit and for assigning the task to one or more applications, and the cloud system further includes a first transmission unit for transmitting to the application to which the task is assigned, detailed information to be used for executing the task, and a second transmission unit for transmitting to the application in response to a request from the application to which the task is assigned, execution data to be used for executing the task.

According to a second aspect, in the information processing system of the first aspect, the cloud system further includes a second registration unit for storing in a second storage unit, schedule setting information in which a schedule of the task is set in response to an operation from the administrator terminal, a first determination unit for determining whether a current time has passed time of the schedule in the schedule setting information stored in the second storage unit, and based on a determination by the first determination unit that the current time has passed the time of the schedule in the schedule setting information, stores the task corresponding to the schedule setting information in the first storage unit.

According to a third aspect, in the information processing system of the second aspect, the second registration unit stores notification destination information of execution results of the task in the second storage unit in response to an operation on the administrator terminal, and the cloud system further includes a reception unit that receives an execution result of the task from the application, and a notification unit that notifies a notification destination indicated by the notification destination information corresponding to the task stored in the second storage unit of the execution result of the task received by the reception unit.

According to a fourth aspect, in the information processing system of the third aspect, the notification destination information is information indicating a notification destination according to a success or failure of the task and a content of the failure of the task.

According to a fifth aspect, in the information processing system of any one of the first aspect to the fourth aspect, the application causes a third storage unit to store in response to a start of the execution of the task, an execution status indicating that the execution of the task is started, and to store in response to a completion of the task, the execution status indicating that the execution of the task is completed, and re-execute the task in a case the task whose execution status is “started” is remaining in the third storage unit at startup.

According to a sixth aspect, in the information processing system of any one of the first aspect to the fifth aspect, the cloud system further includes a measurement unit for measuring latency of a first transmission unit and a second transmission unit and storing the latency in a fourth storage unit, a second determination unit for determining whether the latency stored in the fourth storage unit satisfies a predetermined condition, and based on a determination by the second determination unit that the predetermined condition is satisfied, the acquisition unit acquires one or more tasks.

According to a seventh aspect, an information processing method executed by an information processing system including a cloud system and one or more devices for executing tasks includes, a storage step in which the cloud system stores, in response to an operation on an administrator terminal, a task in a first storage unit, an acquisition step in which the device acquires one or more tasks stored in the first storage unit and assigns the tasks to one or more applications, a first transmission step in which the cloud system transmits to the application to which the task is assigned, detailed information related to an execution of the task, and a second transmission step in which the cloud system transmits to the application in response to a request from the application to which the task is assigned, execution data to be used for execution of the task.

According to an eighth aspect, a program to cause a computer to perform a method including a storage step of storing in response to an operation from the administrator terminal, the task in the first storage unit, when one or more of the tasks registered in the first storage unit are acquired by a device and each task is assigned to one or more applications, a first transmission step of transmitting to the application to which the task is assigned, detailed information related to execution of the task, and a second transmission step of transmitting to the application in response to a request of the application to which the task is assigned execution data to be used for execution of the task.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Any one of the first to fourth storage units may be implemented by, for example, any desired number of databases stored in any desired storage area such as a memory. Further, one or more of the first to fourth storage units may be implemented by any number of memories.

1. An information processing system comprising:
a cloud system including circuitry configured to:
store in response to an operation on an administrator terminal, execution requests for executing one or more tasks in a first memory; and
a device on which a plurality of applications are installed and configured to execute the one or more tasks, the device including circuitry configured to:
acquire the one or more tasks stored in the first memory; and
assign the one or more tasks to one or more applications of the plurality of applications, and
the circuitry of the cloud system is further configured to:
transmit to each application to which the task is assigned, detailed information related to an execution of the task; and
transmit, in response to a request from each application to which the task is assigned, execution data to be used for executing the task to the application.

2. The information processing system of claim 1, wherein
the circuitry of the cloud system is further configured to:
store in a second memory, schedule setting information in which a schedule of the task is set in response to the operation on the administrator terminal;
determine whether a current time has passed a time of the schedule in the schedule setting information; and
based on a determination that the current time has passed the time of the schedule in the schedule setting information, store the task corresponding to the schedule setting information in the first memory.

3. The information processing system of claim 2, wherein
the circuitry of the cloud system is further configured to:
store, in response to the operation on the administrator terminal, notification destination information of an execution result of the task in the second memory;
receive the execution result of the task from the application; and
notify a notification destination indicated by the notification destination information corresponding to the task stored in the second memory of the execution result of the task received from the application.

4. The information processing system of claim 3,
wherein the notification destination information is information indicating the notification destination according to at least one of a success or a failure of the task and a content of the failure of the task.

5. The information processing system of claim 1, wherein
the circuitry of the device is configured to execute the application to:
store, in response to a start of the execution of the task, an execution status indicating that the execution of the task is started in a third memory;
store, in response to a completion of the task, the execution status indicating that the execution of the task is completed in the third memory; and
re-execute the task in a case the task whose execution status indicating that the execution of the task is started is remaining in the third memory at startup.

6. The information processing system of claim 1, wherein
the circuitry of the cloud system is further configured to:
measure latency of transmission of the detailed information and the execution data;
store the latency in a fourth memory;
determine whether the latency satisfies a predetermined condition; and
acquire the one or more tasks based on a determination that the predetermined condition is satisfied.

7. An information processing method executed by a device with a plurality of applications installed and capable of communicating with a cloud system, the method comprising:
acquiring, in response to an operation on an administrator terminal, one or more tasks stored in a first memory of the cloud system;
assigning the one or more tasks to one or more applications of the plurality of applications:
receiving from the cloud system, detailed information related to an execution of the task by each application to which the task is assigned; and
receiving execution data to be used for executing the task, transmitted from the cloud system in response to a request from each application to which the task is assigned.

8. A non-transitory recording medium which, when executed by one or more processors on an information processing apparatus, causes the processors to perform the information processing method comprising:
acquiring, in response to an operation on an administrator terminal, one or more tasks stored in a first memory of a cloud system;
assigning the one or more tasks to one or more applications of a plurality of applications installed on a device;
receiving from the cloud system, detailed information related to an execution of the task by each application to which the task is assigned; and
receiving execution data to be used for executing the task, transmitted from the cloud system in response to a request from each application to which the task is assigned.
